(19) United States
(12) Patent Application Publication
(10) Pub. No.: US 2003/0002810 A1
(43) Pub. Date: Jan. 2, 2003

(54) Illuminating optical fiber plug

(76) Inventor: Yu-Feng Cheng, Tucheng City (TW)

Correspondence Address: PEARNE & GORDON LLP, 526 SUPERIOR AVENUE EAST, SUITE 1200, CLEVELAND, OH, 44114-1484, US

(21) Appl. No.: 09/897,661

(22) Filed: Jul. 2, 2001

(51) Int. Cl. G02B 6/36

(52) U.S. Cl. 385/76; 385/77

(57) ABSTRACT

An illuminating optical fiber plug has a connector made of a transparent material and the connector is received in the housing. The connector has a first end and a second end. The first end extends out of the housing and aligns with an LED in a socket corresponding to the illuminating optical fiber plug. The second end connected to the optical fiber forms an illuminating end on an outer surface of the housing. By such an arrangement, when the illuminating optical fiber plug is plugged in the socket, light signals generated by the LED are able to be observed.

### BACKGROUND OF THE INVENTION

1. Field of the Invention

The present invention relates to an optical fiber plug, and more particularly to an illuminating optical fiber plug which has a transparent hollow connector such that a light signal transmitting in the illuminating optical fiber plug can be observed.

2. Description of Related Art

With the rapid growth of electronic technology, a medium used today for transmitting signals in electronic devices needs to have a significant capacity of transmitting a large quantity of signals. An optical fiber is invented and used in order to satisfy this demand of the high performance medium. The optical fiber can transmit signals in a level of efficiency that a traditional medium such as a copper wire can never reach. Therefore, the optical fiber is becoming an important medium for transmitting signals in the electronic and the photoelectric technology.

To connect the optical fiber to an electronic device, the optical fiber is connected to an optical fiber plug. The optical fiber plug is then plugged in a corresponding socket of the electronic device. With reference to FIGS. 8 and 9, a conventional optical fiber plug (50) has a housing (54) made of a opaque material, a hollow connector (52) also made of the opaque material and protruding from a front end of the housing (54), and a receiving hole (541) defined in a rear portion of the housing (54) to receive an optical fiber (56). Further referring to FIG. 10, when in use, the hollow connector (52) is plugged in a socket (60) of an electronic device, and the optical fiber (56) extends through the optical fiber plug (50) to align with an LED (Light Emitting Diode, 62). The LED (62) is a light source for generating light signals and the light signals are transmitted through the optical fiber (56).

However, due to the housing (54) and the hollow connector (52) being opaque, when the optical fiber plug (50) is plugged in the socket (60), the transmitting condition of the light signals can not be observed by a user. Thus, the user has to unplug the optical fiber plug (50) from the socket (60) to verify whether the LED (62) is sending signals or not and this procedure is not convenient.

Moreover, when the electronic device is not connected to the optical fiber (56), the optical fiber socket (60) can easily be contaminated by dust in the air. To prevent the dust from entering the socket (60), a cap plug is used to cover the socket (60). Again, because the cap plug is made of a opaque material thus the light signal generated by the LED (62) still can not be observed and so the condition of the LED (62) can not be known with the cap plug plugged in the socket (60).

To overcome the shortcomings, the present invention tends to provide an illuminating optical fiber plug to mitigate or obviate the aforementioned problems.

### SUMMARY OF THE INVENTION

The objective of the present invention is to provide an illuminating optical fiber plug which has a transparent hollow connector such that the transmitting condition of a light signal in an optical fiber can be observed.

Another objective of the present invention is to provide an illuminating optical fiber plug having a transparent hollow connector and the illuminating optical fiber plug can be used as a cap plug for an optical fiber socket such that the condition of a light source in the optical fiber socket can be observed.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first preferred embodiment of an illuminating optical fiber plug in accordance with the present invention;

FIG. 2 is a cross-sectional, perspective view of the first preferred embodiment;

FIG. 3 is a cross-sectional, plan view of the first preferred embodiment plugged in a socket;

FIG. 4 is a perspective view of a second preferred embodiment of the illuminating optical fiber plug;

FIG. 5 is a perspective view showing a hollow connector of the second preferred embodiment;

FIG. 6 is a cross-sectional, plan view showing the hollow connector of the second preferred embodiment;

FIG. 7 is a perspective view of a third embodiment of the illuminating optical fiber plug;

FIG. 8 is a perspective view of a conventional optical fiber plug;

FIG. 9 is a cross-sectional, perspective view of the conventional optical fiber plug; and

FIG. 10 is a cross-sectional, plan view of the conventional optical fiber plug plugged in a socket.

### DETAILED DESCRIPTION OF THE PREFERRED EMBODIMENT

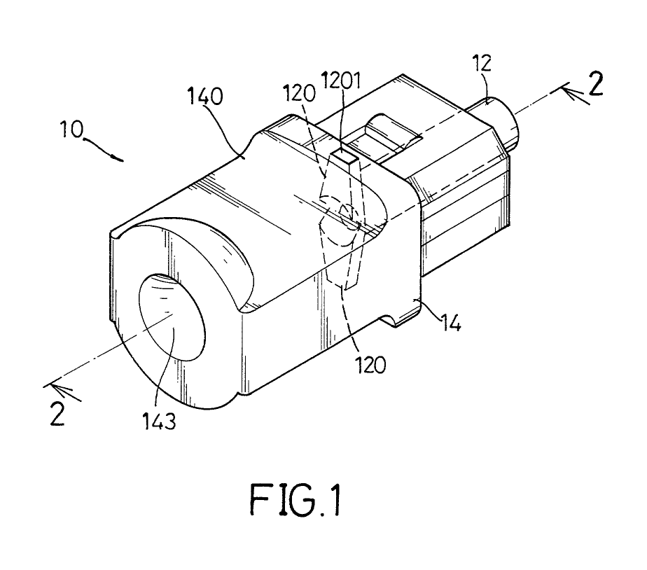

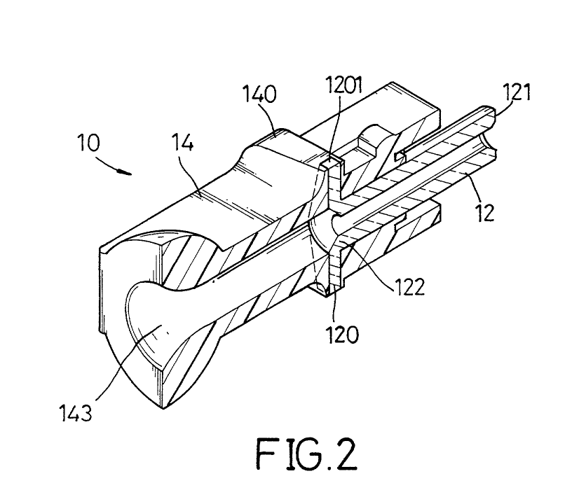

With reference to FIGS. 1 and 2, a first embodiment of an illuminating optical fiber plug (10) in accordance with the present invention has a hollow connector (12) made of a transparent material and a housing (14) made of a opaque material.

The hollow connector (12) is received in the housing (14) and a first end (121) of the hollow connector (12) extends out of a front portion of the housing (14). The hollow connector (12) has a second end (122) received in the housing (14) and the second end (122) diverges into two branch portions (120). The branch portions (120) each has an illuminating end (1201) oppositely extending through the housing (14) to communicate with an outer surface (140) of the housing (14). A receiving hole (143) is defined in a rear portion of the housing (14) and extends into the front portion of the housing (14) to communicate with the second end (122) of the hollow connector (12).

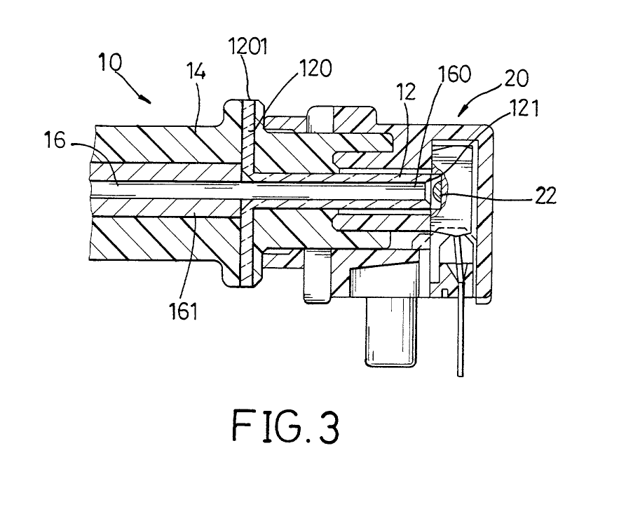

With reference to FIG. 3, an optical fiber (16) has a fiber core (160) and a fiber cladding (161), and the optical fiber (16) extends into the optical fiber plug (10) through the receiving hole (143). The fiber core (160) of the optical fiber (16) further extends into the hollow connector (12).

When in use, still referring to FIG. 3, the optical fiber plug (10) is plugged into a corresponding socket (20) having an LED (22) formed inside the socket (20). The LED (22) aligns with the first end (121) of the hollow connector (12) and the fiber core (160) in the hollow connector (12). Therefore, a light signal generated by the LED (22) is transmitted through the fiber core (160) which aligns with the LED (22) and due to the transparency of the hollow connector (12), each illuminating end (1201) will illuminate and show a flashing dot on the outer surface (140) of the housing (14). Thus, a user can easily know the condition of the light signal transmitting through the optical fiber plug (10) by observing the flashing dot.

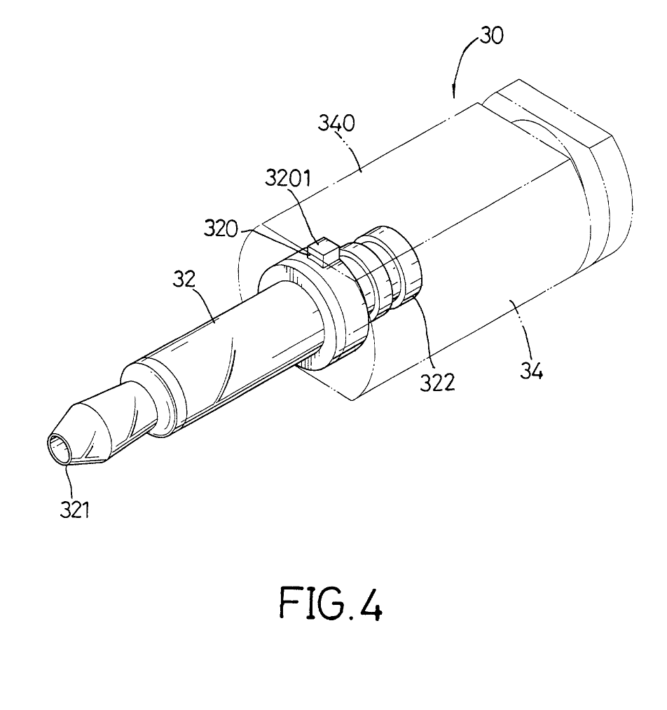

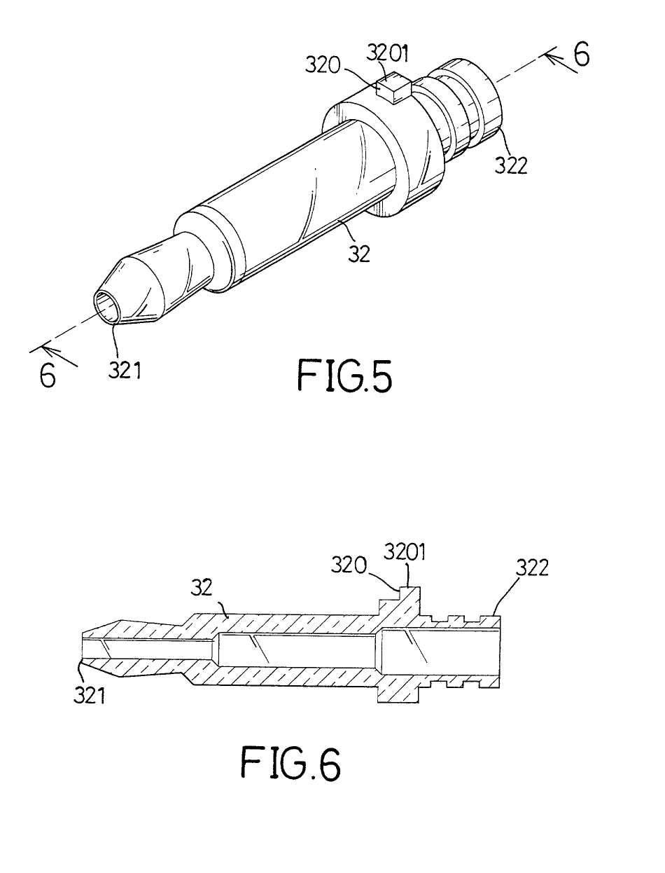

With reference to FIGS. 4-6, a second preferred embodiment of the present invention is formed as a 3.5 φ optical fiber plug which is also commonly used in appliances related to optical fibers to correspond to a 3.5 φ socket (not shown). In this preferred embodiment, an illuminating optical fiber plug (30) has a hollow connector (32) elongated to correspond to the 3.5 φ socket. The hollow connector (32) is made of a transparent material and extended from a housing (34) made of a opaque material. The hollow connector (32) has a first end (321) protruding from a front portion of the housing (34) and a second end (322) received in the housing (34). The second end (322) has an illuminating protrusion (320) radially extending therefrom with an illuminating end (3201) extending through the housing (34) to communicate with an outer surface (340) of the housing (34). Similar to the first preferred embodiment, when in use, an LED (not shown) in the 3.5 φ socket generates a light signal, and due to the transparency of the hollow connector (32), the illuminating end (3201) will illuminate and show a flashing dot on the outer surface (340) of the housing (34) for a user to know the condition of the light signal transmitting through the illuminating optical fiber plug (30).

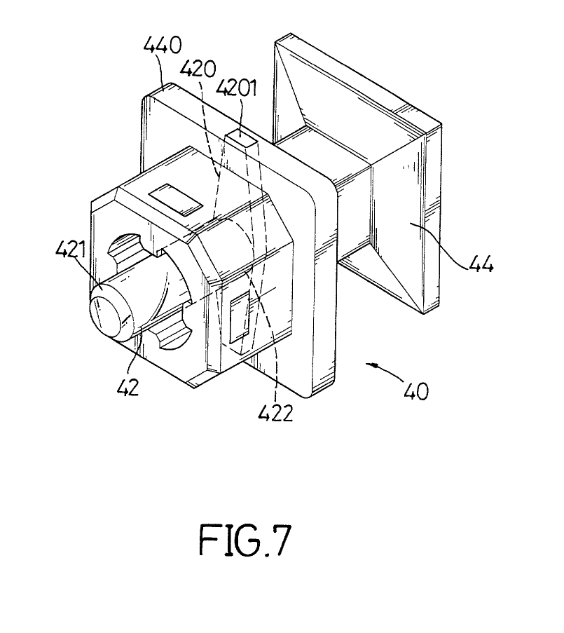

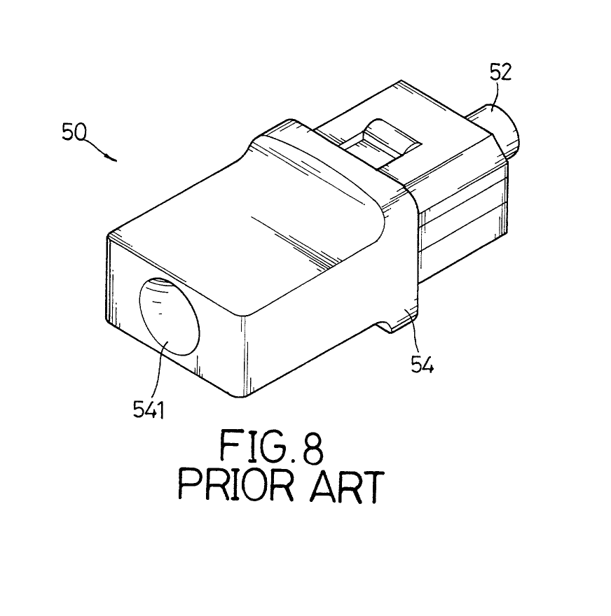

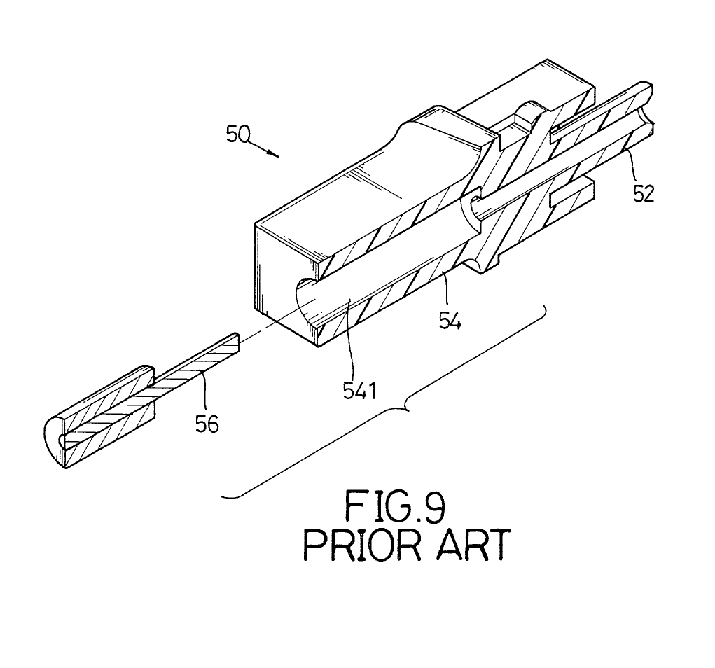

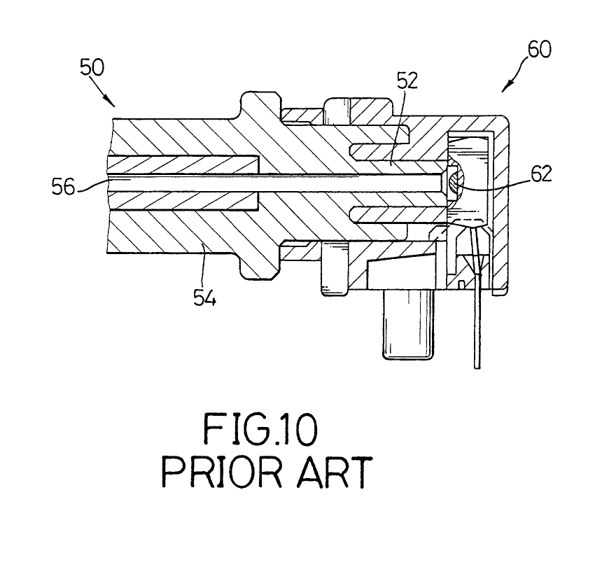

With reference to FIG. 7, a third preferred embodiment of the present invention is shown and formed as a cap plug (40) for the socket (20). The cap plug (40) has a hollow connector (42) made of a transparent material and a housing (44) made of a opaque material. Similar to the first preferred embodiment, the hollow connector (42) has a first end (421) and a second end (422). The first end (421) extends outwardly from the housing to align with the LED (22) in the socket (20). The second end (422) is received in the housing and diverges into two branch portions (420). Each of the branch portions (420) has an illuminating end (4201) extending through the housing (44) to communicate with an outer surface (440) of the housing (44). When the socket (20) is not inserted in the optical fiber plug (10), in order to prevent dust from entering the socket (20), the cap plug (40) is plugged into the socket (20) with the connector (42) aligning with the LED (22). Therefore, when the LED (22) generates the light signal, the illuminating end (4201) illuminates accordingly.

It is noted that the housings (14, 34, and 44) and the hollow connectors (12, 32, and 42) in the preceding preferred embodiment can be integrally formed from a transparent material thus the optical fiber plugs (10 and 30) and the cap plug (40) as a whole can be illuminating. Furthermore, in order to be decorative and to protect human eyes, the optical fiber plugs (10 and 30) and the cap plug (40) that are integrally formed from the transparent material can be formed with a pattern or tinted to reduce the transparency of the optical fiber plugs (10 and 30) and the cap plug (40).

From the above description, it is noted that the invention has the following advantages:

1. The condition of the light signals transmitting through the illuminating optical fiber plug plugged in the socket can be easily known by observing the flashing dot on the housing and the user does not have to unplug the illuminating optical fiber plug to check the condition.

2. The flashing dot can help to indicate the position of the illuminating optical fiber plug especially in a dimly-lit room.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An illuminating optical fiber plug having a housing configured to be received in a socket, a hollow connector having a first end and a second end, the first end of the hollow connector aligning with a light signal source in the socket and the second end of the hollow connector being received in the housing to connect with an optical fiber, the optical fiber having a fiber core extending through the hollow connector and aligning with the light signal source at the first end of the hollow connector to receive light signals generated by the light signal source, wherein the improvements comprises:
the hollow connector being transparent and the second end of the hollow connector having at least one illuminating end penetrating the housing to communicate with an outer surface of the housing,
whereby the light signals transmitting through the illuminating optical fiber plug are able to be observed.

2. The illuminating optical fiber plug as claimed in claim 1, wherein a portion of the housing opposed to the hollow connector defines a receiving hole suitable for receiving the optical fiber and the receiving hole communicates with the hollow connector.

3. The illuminating optical fiber plug as claimed in claim 1, wherein the housing and the hollow connector are integrally formed and both the housing and the hollow connector are transparent.

4. The illuminating optical fiber plug as claimed in claim 2, wherein the housing and the hollow connector are integrally formed and both the housing and the hollow connector are transparent.

5. The illuminating optical fiber plug as claimed in claim 3, wherein the transparent housing is formed with a pattern.

6. The illuminating optical fiber plug as claimed in claim 3, wherein the transparent housing is tinted.

7. The illuminating optical fiber plug as claimed in claim 4, wherein the transparent housing is formed with a pattern.

8. The illuminating optical fiber plug as claimed in claim 4, wherein the transparent housing is tinted.

9. An illuminating optical fiber plug having a housing configured to be received in a socket, a hollow connector having a first end and a second end, the first end of the hollow connector aligning with a light signal source in the socket and the second end received in the housing, wherein the improvements comprises:
the hollow connector being transparent and the second end of the hollow connector having an illuminating end penetrating the housing and communicating with an outer surface of the housing,
whereby light signals generated by the light signal source are able to be observed.

10. The illuminating optical fiber plug as claimed in claim 9, wherein the housing and the hollow connector are integrally formed and both the housing and the hollow connector are transparent.

11. The illuminating optical fiber plug as claimed in claim 10, wherein the transparent housing is formed with a pattern.

12. The illuminating optical fiber plug as claimed in claim 11, wherein the transparent housing is tinted.
